(19) United States
(12) Patent Application Publication
(10) Pub. No.: US 2026/0300047 A1
(43) Pub. Date: Oct. 1, 2026

(54) SYSTEMS AND METHODS OF MANAGING LONG-RUNNING ACTIONS FOR AGENTS

(71) Applicant: Salesforce, Inc., San Francisco, CA (US)

(72) Inventors: Ignacio Agustin Manzano, Pilar (AR); Victor Manuel Romero Carrasco, Malaga (ES); Martin Nicolas Battaglia, Pilar (AR)

(21) Appl. No.: 19/096,910

(22) Filed: Apr. 1, 2025

(51) Int. Cl. G06F 9/54; G06F 16/245

(52) U.S. Cl. CPC G06F 9/542; G06F 9/547; G06F 16/245

(57) ABSTRACT

Systems and methods are provided for receiving, at an agent deployed by a server, a query for information from a user. The agent of the server may analyze the received query and transmitting a list of user-accessible actions to the server. The server may determine that at least one action of the user-accessible actions is a long-running action to provide the information to the user based on the received query. A new action may be generated based on the determination that the at least one action is the long-running action. The server may transmit a first notification to the agent to be presented to the user that the at least one action is the long-running action based on the generated new action. The server may process the long-running action and provide a second notification that includes the information requested by the user.

### BACKGROUND

Agents of software applications or websites are currently limited to synchronous conversations, which poses significant challenges for agents to make API (application program interface) calls during such conversations. The asynchronous operations required for these API calls are incompatible with the current synchronous conversation model due to the extended execution times for some of the API calls.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-3 show an example method of determining and managing long-running actions for an agent responding to a user query according to implementations of the disclosed subject matter.

FIGS. 4A-4B show example systems and workflows of determining and managing long-running actions for an agent responding to a user query according to implementations of the disclosed subject matter.

FIG. 5 shows an example system to perform the example methods of FIGS. 1-3, and the workflow and/or system of FIGS. 4A-4B according to implementations of the disclosed subject matter.

FIG. 6 shows an example computer system to perform the example methods of FIGS. 1-3, the workflow and/or system of FIGS. 4A-4B, and that integrates the system shown in FIG. 5 according to implementations of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter enable an agent of an application and/or website to initiate and/or sustain conversations with a user that involve long-running actions. The system may determine when a prompt (e.g., a query by a user) may take a long time to process and/or respond to, which may cause service disruptions and/or performance degradation. An action may be determined to be long-running based on execution time, resource consumption, protocol restrictions, execution policies, and the like. In some implementations, a domain-specific language (DSL) may be used to describe a set of rules to determine whether an action is long-running.

The long-running action may be detached, and may be replaced with a temporary action that returns a message to the user, notifying them that they will be updated once the process finishes. That is, the agent may notify the user that the processing is in progress for the long-running action, and may inform the user once the process is complete. The user and the agent may continue with their conversation while the long-running action is processed. Alternatively, the user may finish the conversation with the agent and continue with their work until the information is available. That is, the agent may contact the user when the information requested by the user is available from the long-running action.

In current systems, agents are limited to synchronous conversations with users. This poses significant challenges when agent action requires the use of an application programming interface (API) to perform an action. The asynchronous operations required for these API calls are incompatible with the current synchronous conversation model, as the actions that require API calls have long execution times. This incompatibility prevents agents from making these API calls during conversations. Additionally, there is no mechanism for the agent to notify users once a long-running asynchronous operation is completed, and for the agent to continue the conversation with a user. As a result, all current agent conversations remain synchronous. Currently, there is no mechanism to support long-running conversations effectively or enable the agent to initiate conversations by reacting to system behavior to interact with users. Although some conversational agents allow for asynchronous operations as part of their infrastructure architecture, such arrangements may make it unclear to the user that the user’s query is being processed, and the user may be frustrated with waiting for an answer to the user queries.

Implementations of the disclosed subject matter may decouple long-term actions, and provide a way for agents to communicate with users while long-running actions are processed. Notification actions may be executed that inform the user when the agent has completed its execution of the long-running action, and a response to the user request is available. This allows the user and the agent to engage in long asynchronous conversations, which may include long-running actions and API calls to retrieve information and/or process information requested by the user.

Implementations of the disclosed subject matter may enable the agent to initiate and continue conversations. This is in contrast to current systems, where users start interactions by asking the agent for information. In implementations of the disclosed subject matter, agents may start conversations with a user based on system events, and may prompt users before performing actions (e.g., accepting or denying procedures, providing confirmations, or the like). That is, the agent may be configured to initiate a conversation with a user, construct a conversation based on event details, and/or request that the user acknowledge or provide input on an action before proceeding. When the user response, the agent may process the input and continue.

In some implementations, an action metering system may be used as a monitoring and/or metering tool integrated with action execution. It may collect detailed information about actions performed within the context of a conversation.

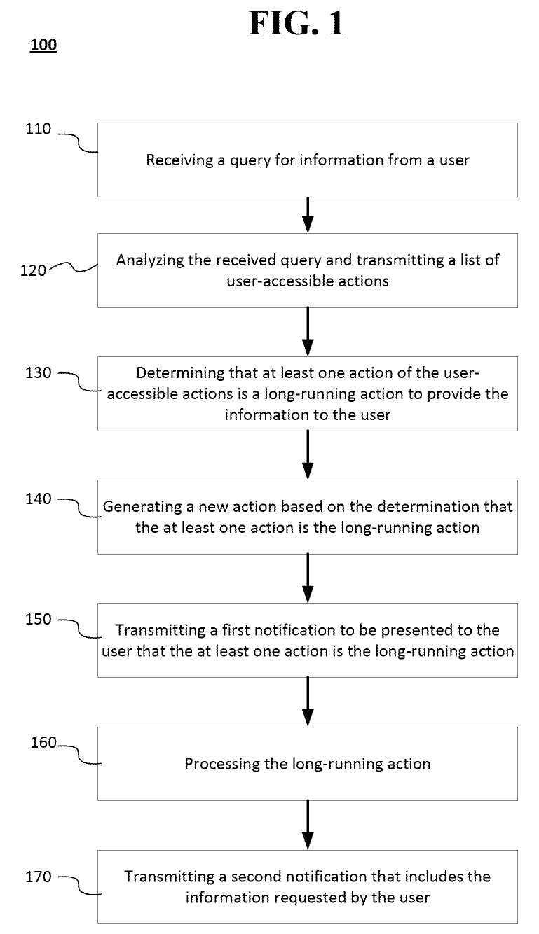

FIGS. 1-3 show an example method 100 of determining and managing long-running actions for an agent responding to a user query according to implementations of the disclosed subject matter.

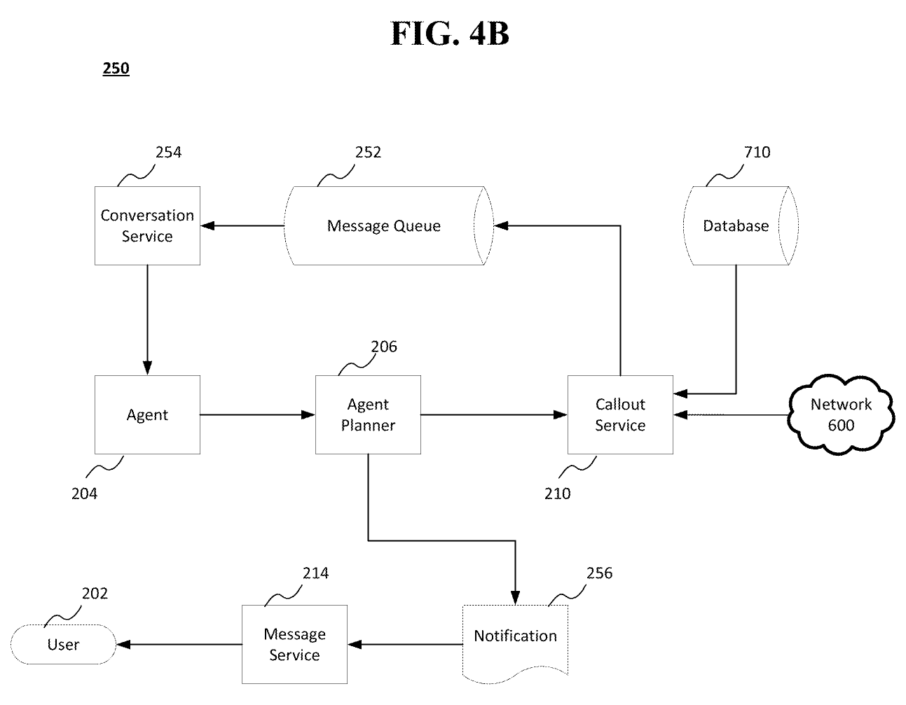

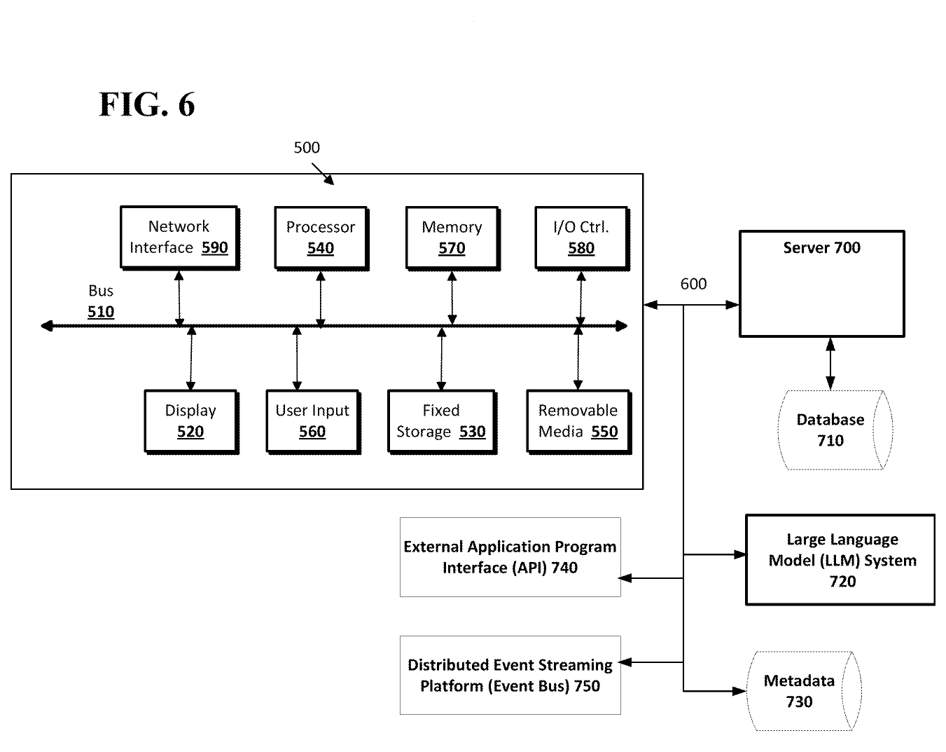

At operation 110, an agent deployed by a server may receive a query for information from a user. For example, the agent may be agent 204 shown in FIG. 4A, which may be deployed by server 700 shown in FIG. 6. In some implementations, the agent may be generated by the server based on a triggering event (e.g., an action by the user in an application, app, and/or website).

At operation 120, the agent may analyze the received query and may transmit a list of user-accessible actions to the server. The user-accessible actions may be one or more actions that are available to a user for an application, app, and/or website via external application program interface (API) 740. In some implementations, the user-accessible actions may depend on a classification, status, and/or type of a user. For example, one user may have more user-accessible actions than another user, based on the classification, status, and/or type associated with the user.

At operation 130, the server may determine that at least one action of the user-accessible actions is a long-running action to provide the information to the user based on the received query. In some implementations, the server may determine that at least one action of the user-accessible actions is a long-running action by determining whether an execution time of the at least one action exceeds a predetermined threshold time, whether an execution of the at least one action consumes an amount of resources that exceeds a predetermined resource limit, whether the at least one action depends on one or more predetermined protocols, and/or whether executing the at least one action exceeds a predetermined number of actions that are executable at a same time. In some implementations, the server may describe the predetermined threshold time, the predetermined resource limit, the one or more predetermined protocols, and/or the predetermined number of actions using a domain-specific language (DSL).

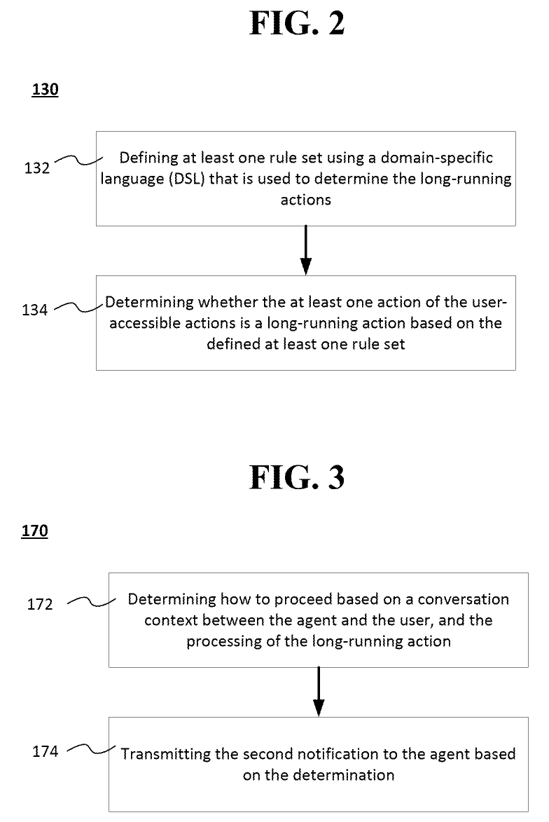

FIG. 2 shows example additional operations that may be performed in connection with operation 130 according to an implementation of the disclosed subject matter. At operation 132, the server may define at least one rule set using a domain-specific language (DSL) that is used to determine the long-running actions. As discussed above, the DSL may define the predetermined threshold time, the predetermined resource limit, the one or more predetermined protocols, and/or the predetermined number of actions that may be used to determine long-running actions. At operation 134, the server may determine whether the at least one action of the user-accessible actions is a long-running action based on the defined at least one rule set.

At operation 140, the server may generate a new action based on the determination that the at least one action is the long-running action. As described below, the new action may replace the long-running action as the long-running action is processed.

At operation 150, the server may transmit a first notification to the agent to be presented to the user that the at least one action is the long-running action based on the generated new action. That is, the new action generated at operation 140 may prompt the server to transmit the notification to inform the user that the long-running action is being processed.

At operation 160, the server may process the long-running action to provide the information requested by the user. In some implementations, the agent may continue a conversation with the user while the long running action is being processed, as discussed in detail below.

At operation 170, the server may transmit a second notification to the agent that includes the information based on the processed long-running action to be provided to the user. That is, the user may be informed by the notification that the long-running action has been processed, and may be provided with the results. These results may answer the user’s query for information that was received at operation 110. In some implementations, the agent may initiate a conversation with the user based on the transmitted information that includes the results to the user’s query.

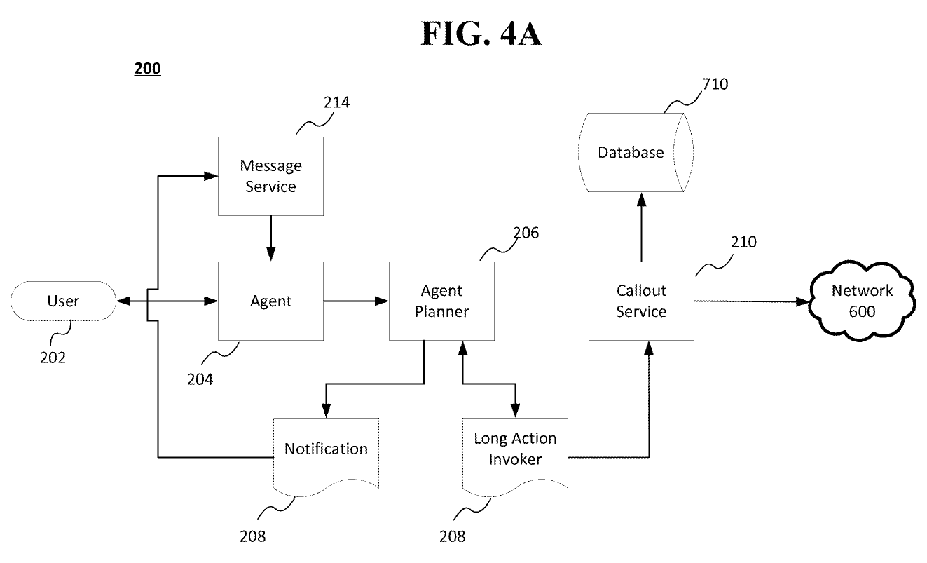

FIG. 3 shows optional additional operations that may be performed in connection with operation 170 according to implementations of the disclosed subject matter. At operation 172, the agent may determine how to proceed based on a conversation context between the agent and the user, as well as by the processing of the long-running action. At operation 174, the server may transmit the second notification to the agent based on the determination. That is, the operations 172 and 174 may determine how to present the information from the long-running action to the user, based on the context of the conversation between the agent and the user.

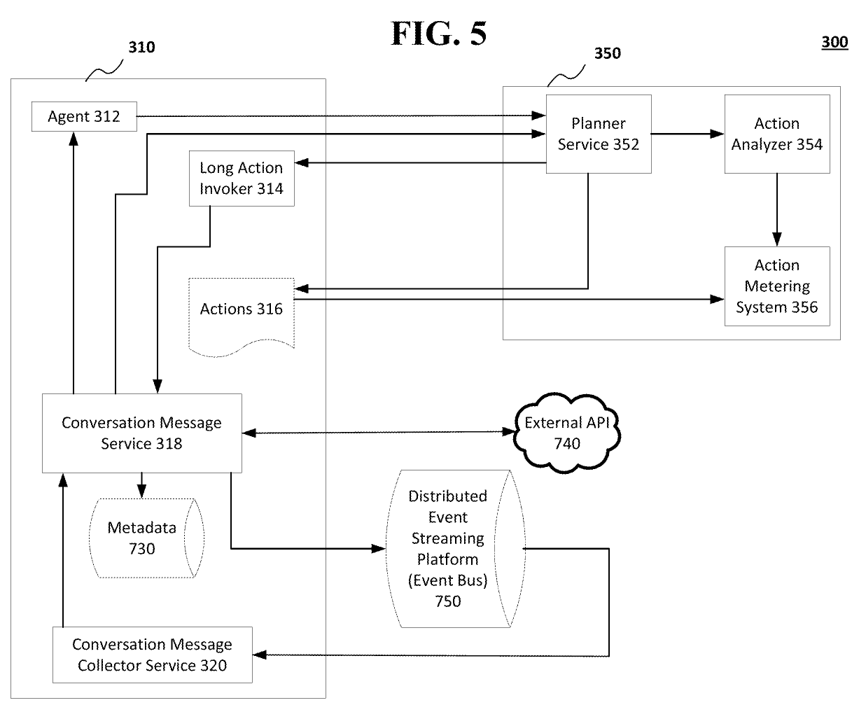

There may be additional optional operations performed by method 100 according to implementations of the disclosed subject matter. For example, the server may monitor at least one action being executed based on a conversation between the agent and the user (e.g., using the action metering system 356 shown in FIG. 5 and described below). The server may monitor the conversation between the agent and the user based on a conversation type, a number of available actions, a number of executed actions, a start time, and an elapsed time. In some implementations, the server may monitor a current action being performed during the conversation between the agent and the user based on at least one selected from a group consisting of: an action name, an action start time, an action end time, a type of invocation of the action, a payload size, and a payload type. The server may monitor resources used by the at least one action that include the memory usage and/or the processor usage.

FIGS. 4A-4B show example systems and workflows of determining and managing long-running actions for an agent responding to a user query according to implementations of the disclosed subject matter. FIG. 4A shows an example system and workflow 200 of determining a long-running action for an agent according to implementations of the disclosed subject matter. User 202 (e.g., a computer 500 shown in FIG. 6) may prompt the agent 204 to request information (e.g., information, content, and/or products of interest to the user). The agent 204 may be generated by server 700 shown in FIG. 6. The agent 204 may analyze the prompt, and may transmit the available list of topics and actions that the user has access to the Agent Planner 206. The agent planner 206 may analyze the available list of topics and actions provided by the agent 204, and may determine that one or more actions are long-running. As described in detail below, an action may be determined to be long-running based on execution time, resource consumption, protocol restrictions, execution policies, and the like. When a long-running action is determined, the agent planner 206 may generate a new action using long action invoker 208.

Long action invoker 208 may provide callout service 210 with the invocation context and/or the necessary information for the callout (e.g., the separation of the long-running action).

As shown in FIG. 4B and described below, the callout service 210 may invoke the separation of the long-running action, and the agent planner 206 may transmit notification 208 to the message service 214 that the invocation is in progress. The agent 204 may notify the user 202 that the processing is in progress, and that the user may be further notified when the processing is complete (as described below in connection with example system and workflow 250 of FIG. 4B). The user 202 may continue with or finish the conversation with the agent 204. As described below in connection with FIG. 4B, the agent 204 may contact the user 202 when the information requested is ready. The long-running action may be transmitted via network 600 (e.g., using external application program interface (API) 740 shown in FIG. 6) to be processed.

The callout service 210 may receive the request, including the action to execute and an identification of the user that made the request (e.g., as identified in a conversation ID). The callout service 210 may be responsible for making the callout (i.e., separating the long-running action) and providing the callback URL (uniform resource locator) to provide the results of the long-running action to. The callout service 210 may store the metadata of the execution to associate the response with the initiator of the conversation. For example, the callout service 210 may store the metadata in database 710 (shown in both system 200 of FIG. 4A and in FIG. 6).

FIG. 4B shows an example system and workflow 250 of returning a response to the user for the long-running action according to implementations of the disclosed subject matter.

The callout service 210 may receive the callback response from the application (e.g., via the communications network 600 from external API 740). With the information from the request, the callout service 210 may retrieve the execution context from the database 710, and may add the response to the message queue 252, which provides the response to the conversation service 254.

The conversation service 252 may be notified of new responses, and may retrieve the corresponding message from the message queue 252. The conversation service 252 may initiate a new conversation with the agent 204, asking to notify the user 204 (e.g., using the original conversation ID) that the requested information is available.

The agent 204 may query the agent planner 206 as to how to proceed, based on the conversation context and the new information received from the long-running action. The agent planner 206 mat determine the one or more actions for proceeding, and may transmit a notification 256 to the user 202 via message service 214. That is, the notification 256 may execute the notification action requested by the agent planner 206, and the message service 214 may proceed to notify the user 202 of the available information in response to the user’s query.

In FIGS. 4A-4B, the agent 204 may be generated by the server 700 shown in FIG. 6, and the agent planner 206, long action invoker 208, callout service 210, message service 214, message queue 252, conversation service 254, and/or notification 256 may be part of the server 700 shown in FIG. 6. The server may be communicatively coupled via communications network 600 to at external API 740, which may be part of one or more servers providing an application, one or more services for an app, and/or one or more services for a website.

FIG. 5 shows an example system 300 to perform the example methods of FIGS. 1-3, and the workflows of FIGS. 4A-4B according to implementations of the disclosed subject matter. System 300 may include core 310 and near-core 350, which may be part of server 700 shown in FIG. 6.

Action analyzer 354 may receive an agent action from agent 312 to execute (e.g., via the planner service 352, which may be similar to and/or the same as agent planner 206 shown in FIGS. 4A-4B), and may analyze one or more factors to determine if the action may be processed independently of the current conversation. This process may include analyzing execution factors, notifying the planner (e.g., planner service 352) of new actions to execute, and the like.

In some implementations, there may be different types of agent actions performed by the agent 312. The action analyzer 354 may begin by executing the action, and evaluating one or more factors to determine whether to decouple the execution. That is, the action analyzer 354 may determine whether the action is a long-running action, and may decouple the action when it is determined to be a long-running action. Examples of the one or more factors to determine whether the action is a long-running action are described below. If the action analyzer 354 determines decoupling the action based on the one or more factors, the action analyzer 354 may transmit a return action to the planner service 352. The conversation between the agent 312 and the user may continue, and the result may be provided when available.

One example factor may be execution time of the action. If the execution time of the action exceeds a predetermined threshold (e.g., X milliseconds), the current execution may be decoupled. Another example factor may be resources. If the execution of an action consumes resources beyond a predetermined threshold (e.g., memory resources, central processing unit (CPU) resources, data storage resources, or the like), the action may be decoupled. Another example factor may be protocol restrictions. Certain actions may depend on specific protocols, such as HTTP (hypertext transfer protocol) actions, where the protocol imposes constraints such as pagination, rate limiting, and the like. For actions with such protocols, the action analyzer 354 may decouple the execution of the action, and may determine when and/or how the conversation between the agent and the user may resume. Another example factor may be execution policies. Some large language model (LLM) systems (e.g., LLM system 720 shown in FIG. 6) may impose restrictions on the number of actions that may be executed. These restrictions may be based on the LLM system’s processing capacity or the like. For example, a user may be limited to executing no more than X actions per conversation. In such scenarios, the action analyzer 354 may decouple the conversation, and may resume the conversation once the policy restrictions are lifted or compliance is restored.

One or more of these factors may be described using a DSL (Domain-Specific Language), and the Action Metering System 356 may monitor the described factors. The DSL may allow developers to define custom rule sets, in addition to having a predetermined number of built-in rule sets. The DSL expressions may be used to define rules, but the action analyzer 354 may evaluate the result of the evaluated rulesets and/or the execution context to determine if the action is to be detached from the current execution.

The DSL may be used to define pre-configured rules employed by the action analyzer 354 to determine how and when to process a decoupled action. Using the DSL, the user may pre-define specific rule for the action analyzer 354. In some implementations, DataWeave^{TM} may be used as the DSL for transformation and action analysis. By using the DSL, the user may take any kind of payload, analyze it, and/or manipulate it.

The action metering system 356, as described below, may collect information about action execution, and may transmit it to the action analyzer 354, enabling informed decisions about whether to decouple execution or continue processing inline.

The action metering system 356 may be a monitoring and/or metering tool integrated with action execution. The action metering system 356 may collect information about actions performed within the context of a conversation. The action metering system 356 may provide telemetry information about the actions. Examples of information to analyze per action execution by the action metering system 356 may include: the conversation between the agent and user (including the type, the number of available actions, the count of executed actions, the start time, the elapsed time, and the like); the current action (e.g., the name, the action start/end, the type of invocation (HTTP, native input/output, database access, and the like), payload size and/or payload type); and/or resources (e.g., memory, CPU, data storage, and the like).

Long action invoker 314 shown in FIG. 5 may be similar to and/or the same as long action invoker 208 shown in FIG. 4A and described above. Long action invoker 314 may be an action implementation to manage the context of long-running executions. Long action invoker 314 may enable the action to be decoupled (when it is determined to be a long-running action), and informs the agent 312 (which may be similar to and/or the same as agent 204 shown in FIGS. 4A-4B) that the long-running action has been decoupled and the conversation between the agent and the user may resume later when the long-running action has been completed. In some implementations, this information may be utilized by an LLM system (e.g., LLM system 720 shown in FIG. 6) to provide an appropriate response to the user.

Conversation message service 318 (which may be the same as and/or similar to message service 214 in FIGS. 4A-4B and described above) may store the execution context (e.g., in metadata database 730) and may transmit the execution context to the distributed event streaming platform (event bus) 750 for asynchronous storage. The distributed event streaming platform (event bus) 750 may be the same as and/or similar to the message queue 252 shown in FIG. 4B and described above. In some implementations, the distributed event streaming platform (event bus) 750 may be Apache Kafka^{TM}, Amazon Kinesis ^{TM}, or the like.

When the executed action completes (via a callback from the external API 740 from an application performing the action), the conversation message service 318 may push the response via the distributed event streaming platform 750, and the conversation message collector service 320 (which may be similar to and/or the same as conversation service 254 of FIG. 4B) may process it.

If a conversation between agent 312 and the user needs to be resumed, the conversation message service 318 may retrieve the relevant metadata from metadata database 730, and may call the agent 312 with the execution context to initiate or continue the conversation.

The conversation message collector service 320 may retrieve the execution context from the distributed event streaming platform (event bus) 750, and may transmit a request to the conversation message service 318 to continue a conversation based on the action response.

In system 300 described above, attaching and detaching an action from a conversation between an agent (e.g., agent 312) and a user may include replacing the current action with one that informs the user they will be notified upon process completion. This may enable handling of long-running actions by system 300 by executing the long-sunning actions asynchronously while maintaining conversation flow between the agent 312 and the user.

When replacing the current action, the original action may be replaced with a temporary action that returns a message to the user, notifying them that an updated may be provided once the long-running action has been processed. The long-running action may be detached from the original conversation. Storing the call and the callback may be executed asynchronously, so that the agent 312 remains responsive. The conversation message service 318 may store the original call and its callback in the distributed event streaming platform (event bus) 750. This operation may allow the action’s progress and/or results to be tracked.

Once the long-running action is complete, the finished event may be pushed onto the event bus 750. The original action's result may be retrieved from the event bus by the conversation message collector service 320, which may perform processing. The processed result may be provided to the conversation message service 318.

For a notification of a new event, the conversation message service 318 may receive the notification of a finished event. This event may include information from the original conversation, details of the executed action, and/or the response from the action.

For resuming the conversation between the agent 312 and the user, the conversation message service 318 may use this event to invoke the planner service 352. The planner service 352 may use the retrieved information and may control the agent 312 to continue the conversation.

The execution context of an action may be important to maintain consistency of actions and/or responses that align with the original conversation flow. Asynchronous execution of the long-running actions may allow the agent 312 to continue a conversation with the user. This arrangement provides traceability, where events may provide a clear audit trail of the process. Implementations of the disclosed subject matter described above may provide robust handling of asynchronous actions while maintaining a smooth and responsive conversational experience for users.

The system 300 shown in FIG. 5 may enable agent 312 to dynamically react to system events and proactively initiate conversations with users. The system 300 may be event-driven, and may use distributed event streaming platform (event bus) 750 to handle communication between the components of system 300 and the agent 312.

System 300 may be capable of detecting an event, and may trigger the process by pushing a conversation message event into the event bus 750. This message represents the initiation of a new conversation and contains all necessary information for the bot to proceed.

The conversation message event may include triggering event information, which may be details about the event that initiated the reaction. The message event may include identification of the user to engage. The message event may include conversation context, which may be relevant data that is used to create a meaningful conversation between the agent 312 and a user.

The conversation message collector service 320 may collect the new message and redirect it to the conversation message service 318. The conversation message service 318 may determine that there is no current conversation enabled, so a new one may be created. The agent 312 may prompt about the event information. A conversational topic may include agent action to notify user by role, agent action management, and/or agent action conversation which may redirect to another agent if the agent identifies that it does not contain the information needed and it can be redirected to a specific conversational agent based on one or more user responses.

The agent 312 may perform conversation creation, user engagement, and/or action management. For conversation creation, the agent 312 may initiate a conversation with the specified user’s role upon receiving a message. For user engagement, the agent 312 may construct the conversation based on the event details, and may ask the user to acknowledge and/or provide input on an action before proceeding. For example, the agent 312 may state “A critical update is scheduled. Do you approve this action?" to get input from a user before proceeding. In another example, the agent 312 may state “We detected unusual activity. Do you want to investigate now?" to get input from a user before proceeding. The agent 312 may engage in action management by processing the user response (i.e., input).

Advantages of event-driven agent conversation may include proactivity, transparency, and/or efficiency. The agent may be proactive by engaging users based on system triggers without waiting for user input. Implementations of the disclosed subject matter may improve transparency by informing users of actions (e.g., long-run actions), and users may be requested by agents to provide consent before execution of an action. The event bus (e.g., event bus 750) may provide seamless communication between systems and the agent. As described above, systems and methods of the disclosed subject matter may allow agents to proactively manage conversations, which may enhance user experience and system reliability.

Implementations of the disclosed subject matter may be implemented in and used with a variety of component and network architectures. FIG. 6 is an example computer 500 may allow a user to interact with the server 700 (or one or more other servers communicatively coupled to communications network 600) that is suitable for the operations detailed in FIGS. 1-3, and which may be part of systems 200 and 250 shown in FIGS. 4A-4B, and/or part of system 300 shown in FIG. 5. Although one server 700 is shown in FIG. 5, there may be a plurality of servers communicatively coupled to communications network 600 to perform the operations detailed in FIGS. 1-3 and/or the workflows of FIGS. 4A-4B. The computer 500 may be a single computer in a network of multiple computers.

In some implementations, the computer 500 may communicate with and may be used to receive one or more responses generated by server 700 (and/or an agent deployed by server 700), the database 710, large language model (LLM) system 720, metadata database 730, external API 740, and/or distributed event streaming platform (event bus) 750 via communications network 600. The server 700, LLM system 720, external API 740, and/or distributed event streaming platform (event bus) 750 may be one or more hardware servers, virtual machines, cloud servers, databases, clusters, application servers, neural network systems, processors, devices, computers, or the like. The database 710 and/or metadata database 730 may use any suitable combination of any suitable volatile and non-volatile physical storage mediums, including, for example, hard disk drives, solid state drives, optical media, flash memory, tape drives, registers, and random access memory, or the like, or any combination thereof. The database 710 may store data, such as tenant data for an application, user data, user profile data, metadata, application data, and the like. Metadata database 730 may store execution context information, conversation information, conversation context information, and the like. LLM system 720 may be used to generate responses and/or statements for an agent (e.g., agent 204 of FIGS. 4A-4B, and/or agent 312 of FIG. 5) deployed by server 700. Such statements may include results from long-running actions that have been processed, as described above in connection with FIGS. 1-5.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks. The service resource 404 and/or one or more user devices 750 may have components that are similar to the computer 500 described above.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 6 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving”, “analyzing”, “determining”, “generating”, “transmitting”, “processing”, or the like, refer to the actions and processes of a computer system, or similar electronic computing device, that manipulates and transforms data represented as physical (e.g., electronic) quantities within the computer system’s registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

In various implementations, the models and/or modules described herein may be classification, predictive, generative, conversational, or another form of artificial intelligence (AI) technology, such as AI model(s), agents, large language models (LLMs), etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology’s output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
receiving, at an agent deployed by a server, a query for information from a user;
analyzing, at the agent of the server, the received query and transmitting a list of user-accessible actions to the server;
determining, at the server, that at least one action of the user-accessible actions is a long-running action to provide the information to the user based on the received query;
generating, at the server, a new action based on the determination that the at least one action is the long-running action;
transmitting, at the server, a first notification to the agent to be presented to the user that the at least one action is the long-running action based on the generated new action;
processing, at the server, the long-running action to provide the information requested by the user; and
transmitting, at the server to the agent, a second notification that includes the information based on the processed long-running action to be provided to the user.

2. The method of claim 1, wherein the determining that at least one action of the user-accessible actions is a long-running action by determining at least one selected from a group consisting of: whether an execution time of the at least one action exceeds a predetermined threshold time, whether an execution of the at least one action consumes an amount of resources that exceeds a predetermined resource limit, whether the at least one action depends on one or more predetermined protocols, and whether executing the at least one action exceeds a predetermined number of actions that are executable at a same time.

3. The method of claim 2, further comprising:
describing, at the server, a least one selected from a group consisting of: the predetermined threshold time, the predetermined resource limit, the one or more predetermined protocols, and the predetermined number of actions using a domain-specific language (DSL).

4. The method of claim 1, wherein the determining that that at least one action of the user-accessible actions is a long-running action comprises:
defining, at the server, at least one rule set using a domain-specific language (DSL) that is used to determine the long-running actions; and
determining, at the server, whether the at least one action of the user-accessible actions is a long-running action based on the defined at least one rule set.

5. The method of claim 1, wherein the transmitting the second notification comprises:
determining, at the agent, how to proceed based on a conversation context between the agent and the user, and the processing of the long-running action; and
transmitting, at the server, the second notification to the agent based on the determination.

6. The method of claim 1, further comprising:
monitoring, at the server, at least one action being executed based on a conversation between the agent and the user.

7. The method of claim 6, wherein the server monitors the conversation between the agent and the user based on at least one selected from a group consisting of: a conversation type, a number of available actions, a number of executed actions, a start time, and an elapsed time.

8. The method of claim 6, wherein the server monitors a current action being performed during the conversation between the agent and the user based on at least one selected from a group consisting of: an action name, an action start time, an action end time, a type of invocation of the action, a payload size, and a payload type.

9. The method of claim 6, wherein the server monitors resources used by the at least one action that include at least one selected from a group consisting of: memory usage, and processor usage.

10. The method of claim 1, further comprising:
initiating, at the agent, a conversation with the user based on the transmitted information.

11. A system comprising:
a server including at least one hardware processor, the server configured to:
receive, at an agent deployed by the server, a query for information from a user;
receive a list of user-accessible actions from the agent based on the received query;
analyze, at the agent to the server, the received query and transmitting a list of user-accessible actions to the server;
determine that at least one action of the user-accessible actions is a long-running action to provide the information to the user based on the received query;
generate a new action based on the determination that the at least one action is the long-running action;
transmit a first notification to the agent to be presented to the user that the at least one action is the long-running action based on the generated new action;
process the long-running action to provide the information requested by the user; and
transmit a second notification to the agent that includes the information based on the processed long-running action to be provided to the user.

12. The system of claim 11, wherein the server is configured to determine that at least one action of the user-accessible actions is a long-running action by determining at least one selected from a group consisting of: whether an execution time of the at least one action exceeds a predetermined threshold time, whether an execution of the at least one action consumes an amount of resources that exceeds a predetermined resource limit, whether the at least one action depends on one or more predetermined protocols, and whether executing the at least one action exceeds a predetermined number of actions that are executable at a same time.

13. The system of claim 12, wherein the server is further configured to use a domain-specific language (DSL) to describe a least one selected from a group consisting of: the predetermined threshold time, the predetermined resource limit, the one or more predetermined protocols, and the predetermined number of actions.

14. The system of claim 11, wherein the server is configured to determine that at least one action of the user-accessible actions is a long-running action by defining at least one rule set using a domain-specific language (DSL) that is used to determine the long-running actions, and determine whether the at least one action of the user-accessible actions is a long-running action based on the defined at least one rule set.

15. The system of claim 11, wherein the server is configured to transmit the second notification by determining how to proceed based on a conversation context between the agent and the user, and the processing of the long-running action, and transmitting the second notification to the agent based on the determination.

16. The system of claim 11, wherein the server is configured to monitor at least one action being executed based on a conversation between the agent and the user.

17. The system of claim 16, wherein the server is configured to monitor the conversation between the agent and the user based on at least one selected from a group consisting of: a conversation type, a number of available actions, a number of executed actions, a start time, and an elapsed time.

18. The system of claim 16, wherein the server is configured to monitor a current action being performed during the conversation between the agent and the user based on at least one selected from a group consisting of: an action name, an action start time, an action end time, a type of invocation of the action, a payload size, and a payload type.

19. The system of claim 16, wherein the server is configured to monitor resources used by the at least one action that include at least one selected from a group consisting of: memory usage, and processor usage.
